(19) United States
(12) Patent Application Publication
(10) Pub. No.: US 2014/0373005 A1
(43) Pub. Date: Dec. 18, 2014

(54) REQUIREMENT BASED EXPOSURE OF ENGINES OF A GRAPHICS PROCESSING UNIT (GPU) TO A VIRTUAL MACHINE (VM) CONSOLIDATED ON A COMPUTING PLATFORM

(71) Applicant: NVIDIA Corporation, Santa Clara, CA (US)

(72) Inventors: Ankit R. Agrawal, Amravati (IN); Bibhuti Bhusban Narayan Prusty, Bhubaneshwar (IN); Surath Raj Mitra, Behala (IN)

(73) Assignee: NVIDIA Corporation, Santa Clara, CA (US)

(21) Appl. No.: 13/915,630

(22) Filed: Jun. 12, 2013

(51) Int. Cl. G06F 9/455

(52) U.S. Cl. CPC G06F 9/45533
USPC 718/1

(57) ABSTRACT

A method includes executing a driver component on a hypervisor of a computing platform including a graphics processing unit (GPU) executing a number of engines thereon, and executing an instance of the driver component in each of a number of VMs consolidated on the computing platform. The method also includes defining, through the hypervisor, a data path between a VM and a subset of the engines of the GPU in a configuration register associated with the VM in accordance with a requirement of an application executing on the VM, and reading, through the instance of the driver component in the VM, an emulated version of the configuration register during loading thereof. Further, the method includes limiting one or more processing functionalities provided to the VM based on solely exposing the subset of the engines to the application in accordance with the data path definition in the configuration register.

### FIELD OF TECHNOLOGY

This disclosure relates generally to virtualized computing platforms and, more particularly, to requirement based exposure of engines of a Graphics Processing Unit (GPU) to a virtual machine (VM) consolidated on a computing platform.

### BACKGROUND

A hypervisor may consolidate VMs on a computing platform including a GPU to enable sharing of engines executing on the GPU between the VMs. The GPU may be part of a GPU system including a number of other GPUs. Engines of the GPU shared with a VM may be different from engines of another GPU. The difference in engines between the GPUs may render a process of migration of the VM between the GPU and the another GPU extremely challenging.

### SUMMARY

Disclosed are a method, a device and/or a system of requirement based exposure of engines of a Graphics Processing Unit (GPU) to a virtual machine (VM) consolidated on a computing platform.

In one aspect, a method includes executing a driver component on a hypervisor of a computing platform including a GPU. The hypervisor is configured to consolidate a number of VMs on the computing platform and to virtualize resources thereof. The GPU executes a number of engines thereon. The method also includes executing an instance of the driver component in each of the number of VMs, and defining, through the hypervisor, a data path between a VM and a subset of the engines of the GPU in a configuration register associated with the VM in accordance with a requirement of an application executing on the VM.

Further, the method includes reading, through the instance of the driver component in the VM, an emulated version of the configuration register during loading thereof, and limiting, through the hypervisor, one or more processing functionalities provided to the VM based on solely exposing the subset of the engines of the GPU to the application executing thereon in accordance with the data path definition in the configuration register.

In another aspect, a non-transitory medium, readable through a computing platform and including instructions embodied therein that are executable through the computing platform, is disclosed. The non-transitory medium includes instructions to execute a driver component on a hypervisor of the computing platform including a GPU. The hypervisor is configured to consolidate a number of VMs on the computing platform and to virtualize resources thereof. The GPU executes a number of engines thereon. The non-transitory medium also includes instructions to execute an instance of the driver component in each of the number of VMs, and instructions to define, through the hypervisor, a data path between a VM and a subset of the engines of the GPU in a configuration register associated with the VM in accordance with a requirement of an application executing on the VM.

Further, the non-transitory medium includes instructions to read, through the instance of the driver component in the VM, an emulated version of the configuration register during loading thereof, and instructions to limit, through the hypervisor, one or more processing functionalities provided to the VM based on solely exposing the subset of the engines of the GPU to the application executing thereon in accordance with the data path definition in the configuration register.

In yet another aspect, a computing platform includes a memory and a GPU communicatively coupled to the memory. The GPU is configured to execute a number of engines thereon. The computing platform also includes a hypervisor configured to consolidate a number of VMs thereon and to virtualize resources thereof. The hypervisor includes a driver component executing thereon. Each of the number of VMs executes an instance of the driver component thereon. The hypervisor is further configured to: define a data path between a VM and a subset of the engines of the GPU in a configuration register associated with the VM in accordance with a requirement of an application executing on the VM, and limit one or more processing functionalities provided to the VM based on solely exposing the subset of the engines of the GPU to the application executing thereon in accordance with the data path definition in the configuration register.

The instance of the driver component in the VM is configured to read an emulated version of the configuration register during loading thereof.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a hypervisor-based computing system including a Graphics Processing Unit (GPU) communicatively coupled to a memory.

FIG. 2 is a schematic view of a hypervisor-based computing system configured to enable exposure of only a subset of engines of a GPU thereof to each virtual machine (VM) consolidated on a computing platform thereof, according to one or more embodiments.

FIG. 3 is a schematic view of an example scenario of utilization of the computing platform of FIG. 2, according to one or more embodiments.

FIG. 4 is a process flow diagram detailing the operations involved in requirement based exposure of engines of the GPU of FIG. 2 to a VM consolidated on the computing platform of FIG. 2, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of requirement based exposure of engines of a Graphics Processing Unit (GPU) to a virtual machine (VM) consolidated on a computing platform. Although the present embodiments have been described with reference to specific example embodiments, it will be evident that various modifications and changes may be made to these embodiments without departing from the broader spirit and scope of the various embodiments.

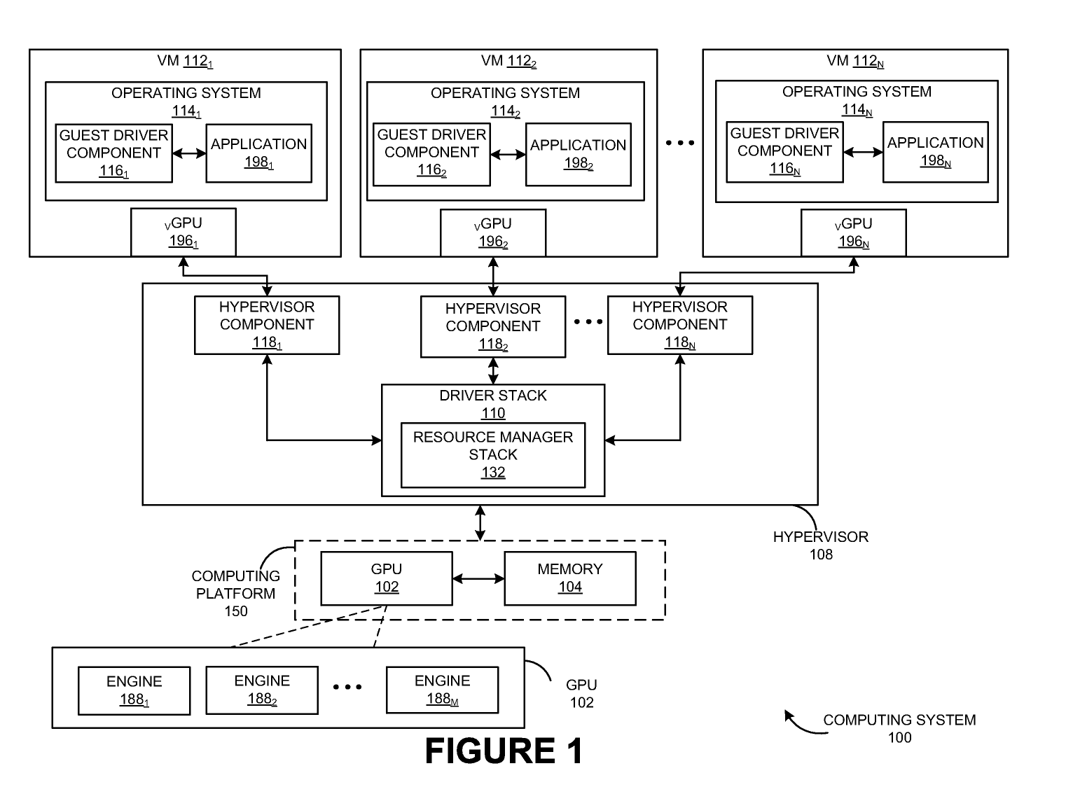

FIG. 1 shows a hypervisor-based computing system 100 including a Graphics Processing Unit (GPU) 102 communicatively coupled to a memory 104 (e.g., volatile memory and/or non-volatile memory). Memory 104 may include storage locations configured to be addressable through GPU 102 (e.g., nVIDIA®'s VGX™ GPU). GPU 102 and memory 104 may be part of a computing platform 150 associated with computing system 100. It is obvious that computing system 100 may also include a Central Processing Unit (CPU) (not shown).

A hypervisor 108 may execute on computing platform 150; hypervisor 108 may be a high-level system software or a program enabling multiple operating systems share hardware resources of computing platform 150. Hypervisor 108 may control GPU 102 and memory 104 and resources of computing platform 150 to abstract each of the multiple operating systems; hypervisor 108 may consolidate virtual machines (VMs) on computing platform 150.

FIG. 1 shows a driver stack 110 executing on hypervisor 108 and a number of VMs 112_{1-N} consolidated on computing platform 150 through hypervisor 108. Each VM 112_{1-N} may execute a corresponding operating system 114_{1-N} therethrough. Each VM 112_{1-N} may also execute a guest driver component 116_{1-N} and may have a corresponding hypervisor component 118_{1-N} executing on hypervisor 108; hypervisor component 118_{1-N} may virtualize resources of GPU 102 and interact with the device emulation mechanism thereof (for example, hypervisor 108 may include a device emulation module therefor; components of a hypervisor and functionalities thereof are well-known to one of ordinary skill in the art; therefore, detailed discussion associated therewith has been skipped for the sake of brevity and convenience). Driver stack 110 may enable setting up of resources of GPU 102 (e.g., per VM channel) for guest driver component 116_{1-N}; once a guest driver component 116_{1-N} has requisite resources of GPU 102 allocated thereto, guest driver component 116_{1-N} may directly communicate with GPU 102, without intervention of driver stack 110.

Driver stack 110 may include a resource manager stack 132 to manage assignment of resources of computing platform 150 to VMs 112_{1-N}. Resource manager stack 132 may enable hypervisor 108 provide a virtualized GPU instance (vGPU) 196_{1-N} to each VM 112_{1-N}. GPU 102 may include a number of engines 188_{1-M} (e.g., sets of instructions), each of which is configured to realize one or more specific functionalities. For example, a first engine 188₁ may handle rendering of data, a second engine 188₂ may handle scanning out the rendered data onto a screen of a display unit (not shown), a third engine 188₃ may perform video encoding and so on. The aforementioned engines 188_{1-M} may work independently during handling requests for functionalities thereof and/or in parallel with one another.

As shown in FIG. 1, each VM 112_{1-N} may execute an application 198_{1-N} thereon; application 198_{1-N} is shown as being part of operating system 114_{1-N}. In many scenarios, a number of applications 198_{1-N} may utilize only a subset of GPU engines 188_{1-M}. For example, a video encoding application 198₃ may mainly utilize engine 188₃; another application 198₅ may majorly rely on a graphics engine 188₅. However, in these scenarios, all engines 188_{1-M} of GPU 102 may be exposed to each VM 112_{1-N}.

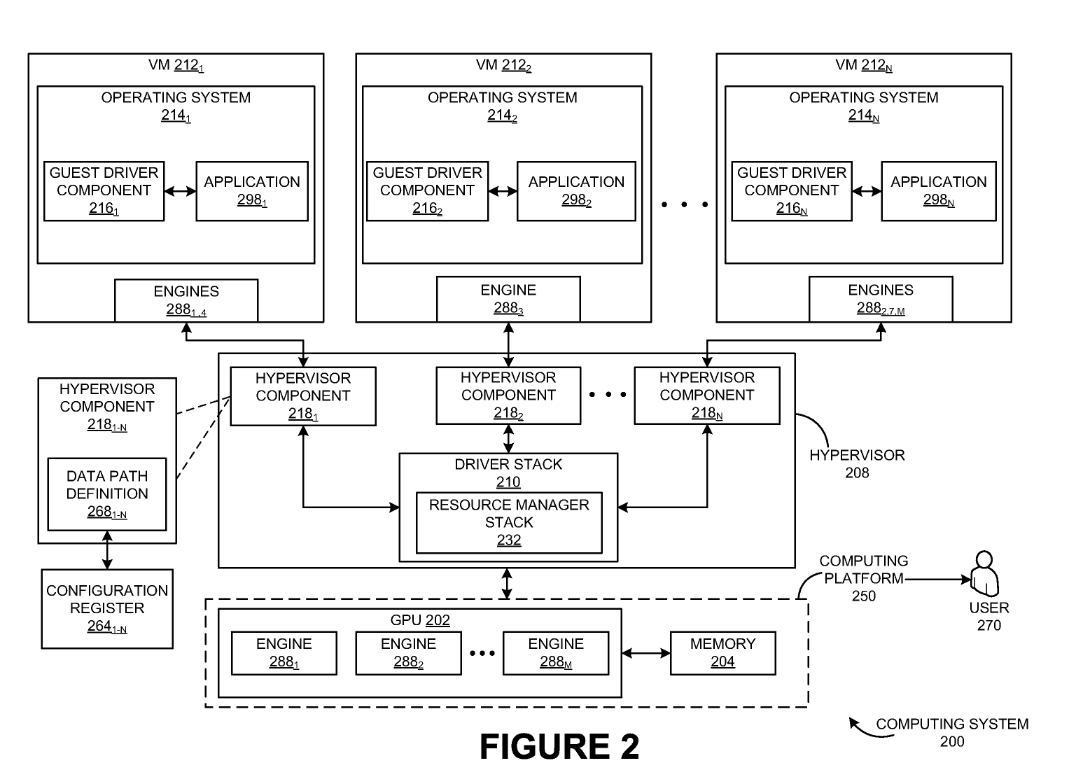

Further, a challenge of VM migration may be to migrate a VM 112_{1-N} from GPU 102 to another GPU when GPU 102 and the another GPU differ in engines 188_{1-M} supported therethrough. FIG. 2 shows a computing system 200 configured to enable exposure of only a subset of GPU engines 288_{1-M} (analogous to GPU engines 188_{1-M}) to each VM 212_{1-N} (analogous to VM 112_{1-N}), according to one or more embodiments. In one or more embodiments, GPU 202, memory 204, computing platform 250, hypervisor 208, driver stack 210, operating system 214_{1-N}, guest driver component 216_{1-N}, hypervisor component 218_{1-N}, resource manager stack 232 and application 298_{1-N} may be analogous to GPU 102, memory 104, computing platform 150, hypervisor 108, driver stack 110, operating system 114_{1-N}, guest driver component 116_{1-N}, hypervisor component 118_{1-N}, resource manager stack 132 and application 198_{1-N} respectively.

In one or more embodiments, computing system 200 may enable specifying functionalities from a side of computing platform 250. In one or more embodiments, a user 270 (e.g., an administrator) of computing platform 250 may decide on the subset of engines 288_{1-M} that is exposed to each VM 212_{1-N} based on defining the limited functionalities associated therewith through hypervisor component 218_{1-N}. Thus, in one or more embodiments, only a subset of engines 288_{1-M} may be exposed to each VM 212_{1-N} through the definition in hypervisor component 218_{1-N}. In one or more embodiments, hypervisor component 218_{1-N} may be configured to have a data path defined (e.g., data path definition 268_{1-N}) between the each VM 212_{1-N} and a desired subset of engines 288_{1-M} therein. For example, data path definition 268₁ for VM 212₁ may be different from data path definition 268₂ for VM 212₂. Here, different subsets of engines 288_{1-M} may be exposed to different VMs 212_{1-N}. FIG. 2 shows engines 288_{1,4} being exposed to VM 212₁, engine 288₃ being exposed to VM 212₂ and engine 288_{2,7,M} being exposed to VM 212_{N} for example purposes.

In one or more embodiments, data path definitions 268_{1-N} and/or configuration settings associated therewith may be made available through hypervisor component 218_{1-N} in one or more configuration register(s). In one or more embodiments, hypervisor component 218_{1-N} may enable guest driver component 216_{1-N} access an emulated version of the one or more configuration register(s) (e.g., configuration register 264_{1-N} shown as being associated with hypervisor component 218_{1-N}; it should be noted that configuration register 264_{1-N} may include one or more configuration register(s) therein). In one or more embodiments, during loading of guest driver component 216_{1-N}, guest driver component 216_{1-N} may read configuration register 264_{1-N} to track the subset of engines 288_{1-M} available thereto and capabilities/configuration(s) associated therewith.

Thus, in one or more embodiments, functionalities exposed to VMs 212_{1-N} may be specified from the side of computing platform 250; hypervisor component 218_{1-N} may provide configuration(s) available to guest driver component 216_{1-N} executing on VM 212_{1-N}. In one or more embodiments, hypervisor component 218_{1-N} may solely expose an appropriate emulated configuration register 264_{1-N} to a guest driver component 216_{1-N}, where configuration register 264_{1-N} may include information related to the subset of engines 288_{1-M} available to said guest driver component 216_{1-N}. In one or more embodiments, as discussed above, guest driver component 216_{1-N} may read the configuration space (e.g., configuration register 264_{1-N} associated therewith) during loading thereof and determine the subset of engines 288_{1-M} allocated to VM 212_{1-N}; other engines 288_{1-M} may not be exposed thereto.

In one or more embodiments, the decision to expose subsets of engines 288_{1-M} to VMs 212_{1-N} as per requirements thereof may be made during creation of VMs 212_{1-N}. It should be noted that the aforementioned decision-making and/or creation of data path definitions 268_{1-N}/configuration registers 264_{1-N} may dynamically occur during creation of VMs 212_{1-N}. Pre-configuring hypervisor component 218_{1-N} (configuration register 264_{1-N}) with data path definition 268_{1-N} through resource manager stack 232 is also within the scope of the exemplary embodiments discussed herein.

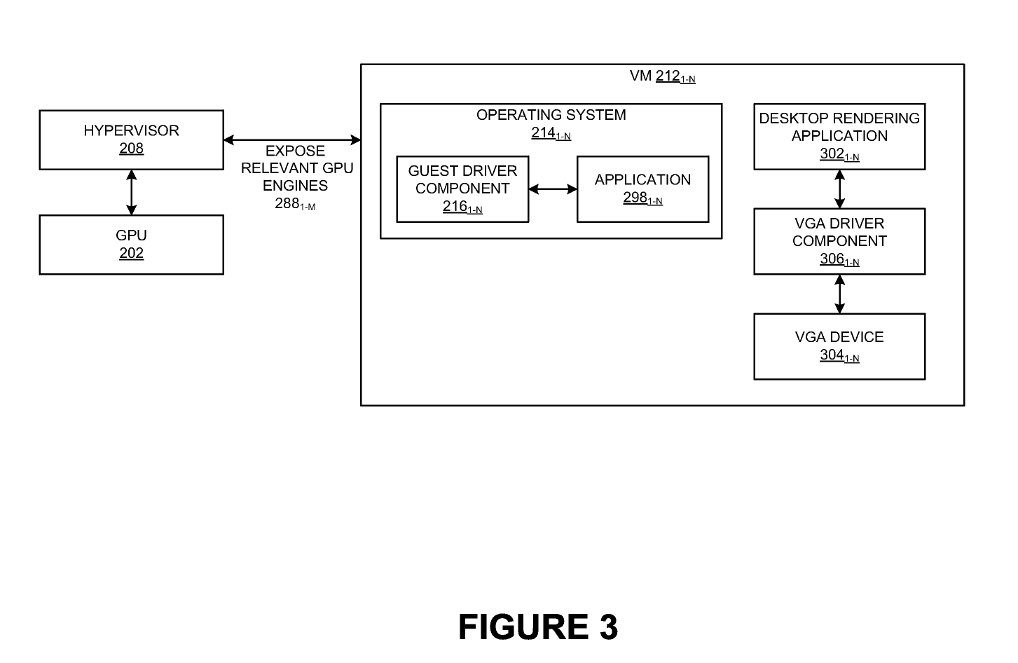

FIG. 3 shows an example scenario to which exemplary embodiments may be applicable. Here, application 298_{1-N} executing on operating system 214_{1-N} may require hardware acceleration for a video encoding process. Application 298_{1-N} may communicate with guest driver component 216_{1-N}, for example, through standard Application Programming Interface(s) (API(s); not shown). Guest driver component 216_{1-N} may then request hypervisor component 218_{1-N} to set up resources therefor. Hypervisor component 218_{1-N} may set up resources for VM 212_{1-N} through resource manager stack 232. Now, guest driver component 216_{1-N} may directly transmit commands to GPU 202 to execute a request for hardware acceleration. Here, as discussed above, the relevant subset of GPU engines 288_{1-M} alone may be exposed to VM 212_{1-N}. FIG. 3 also shows a desktop rendering application 302_{1-N} executing on VM 212_{1-N}. Here, VM 212_{1-N} may include a software emulated Video Graphics Array (VGA) device 304_{1-N} associated with a user at a client device (not shown) requiring the hardware acceleration. A VGA driver component 306_{1-N} may also be loaded on VM 212_{1-N}; said

VGA driver component 306_{1-N} may interact between desktop rendering application 302_{1-N} and VGA device 304_{1-N}. It should be noted that the desktop rendering discussed herein is merely for contextual purposes; the desktop rendering application 302_{1-N} may provide an interface to the user with respect to the desktop rendering.

In one or more embodiments, sharing subsets of GPU engines 288_{1-M} alone as discussed above may provide for efficient overall utilization of GPU 202. Further, migration of a VM from one GPU (e.g., GPU 202) to another GPU when the two GPUs differ in the engines supported therethrough may prove to be a challenge. Exemplary embodiments also provide for a means to meet the aforementioned challenge through solely exposing a subset of engines (e.g., engines 288_{1-M}) common to both GPUs. In one or more embodiments, if the subset of GPU engines exposed to the VM (e.g., VM 212_{1-N}) is available in both GPUs, the VM can be migrated from one GPU (e.g., GPU 202) to another. It should be noted that GPU 202 may be part of a GPU system including a number of GPUs; the GPU system also may include the another GPU. Here, hypervisor 208 may configure the another GPU with the subset of GPU engines exposed to the VM through the GPU.

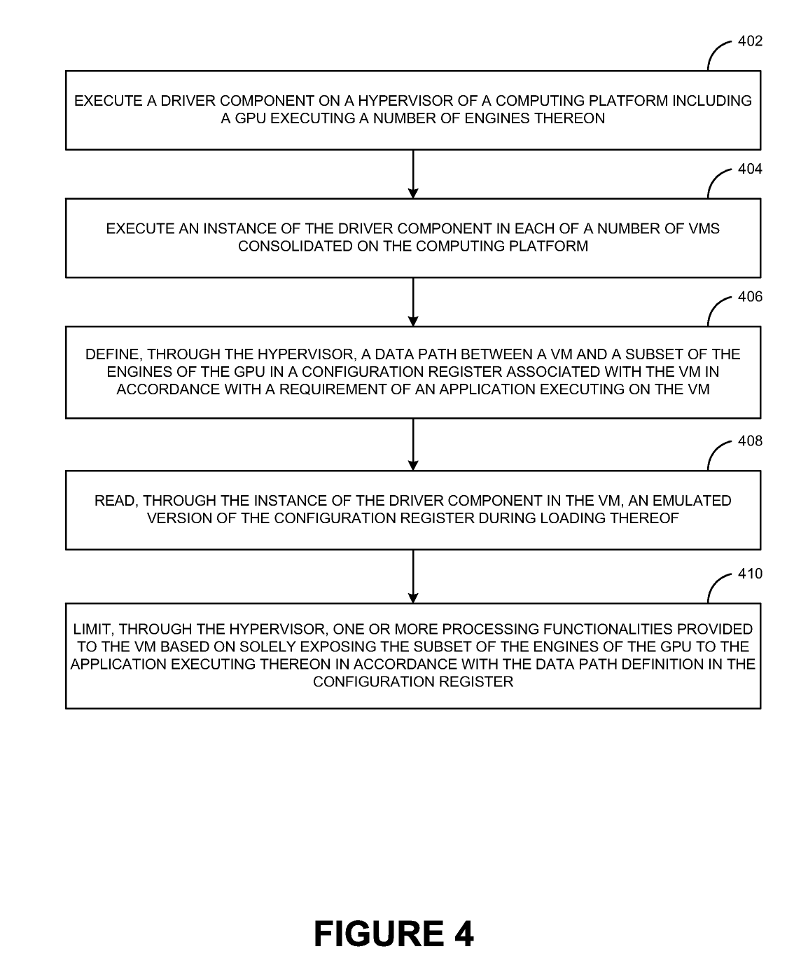

FIG. 4 shows a process flow diagram detailing the operations involved in requirement based exposure of GPU engines 288_{1-M} to VM 212_{1-N} consolidated on computing platform 250, according to one or more embodiments. In one or more embodiments, operation 402 may involve executing a driver component (e.g., hypervisor component 218_{1-N}) on hypervisor 208. In one or more embodiments, operation 404 may involve executing an instance of the driver component (e.g., guest driver component 216_{1-N}) in each VM 212_{1-N}. In one or more embodiments, operation 406 may involve defining, through hypervisor 208, a data path between VM 212_{1-N} and a subset of the engines 288_{1-M} in configuration register 264_{1-N} associated with VM 212_{1-N} in accordance with a requirement of application 298_{1-N} executing on VM 212_{1-N}. In one or more embodiments, operation 408 may involve reading, through guest driver component 216_{1-N}, an emulated version of configuration register 264_{1-N} during loading thereof.

In one or more embodiments, operation 410 may then involve limiting, through hypervisor 208, one or more processing functionalities provided to VM 212_{1-N} based on solely exposing the subset of engines 288_{1-M} to application 298_{1-N} executing thereon in accordance with the data path definition (e.g., data path definition 268_{1-N}) in configuration register 264_{1-N}.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a non-transitory machine-readable medium). For example, the various electrical structures and methods may be embodied using transistors, logic gates, and electrical circuits (e.g., Application Specific Integrated Circuitry (ASIC) and/or Digital Signal Processor (DSP) circuitry).

In addition, it will be appreciated that the various operations, processes, and methods disclosed herein may be embodied in a non-transitory machine-readable medium (e.g., a Compact Disc (CD), a Digital Video Disc (DVD), a Blu-ray disc®, a hard drive; appropriate instructions may be downloaded to the hard drive) and/or a machine-accessible medium compatible with a data processing system (e.g., computing system 200; computing platform 250), and may be performed in any order (e.g., including using means for achieving the various operations).

Accordingly, the specification and the drawings are to be regarded in an illustrative rather than a restrictive sense.

What is claimed is:

1. A method comprising:
executing a driver component on a hypervisor of a computing platform comprising a graphics processing unit (GPU), the hypervisor being configured to consolidate a plurality of virtual machines (VMs) on the computing platform comprising the GPU and to virtualize resources thereof, and the GPU executing a plurality of engines thereon;
executing an instance of the driver component in each of the plurality of VMs;
defining, through the hypervisor, a data path between a VM and a subset of the engines of the GPU in a configuration register associated with the VM in accordance with a requirement of an application executing on the VM;
reading, through the instance of the driver component in the VM, an emulated version of the configuration register during loading thereof; and
limiting, through the hypervisor, at least one processing functionality provided to the VM based on solely exposing the subset of the engines of the GPU to the application executing thereon in accordance with the data path definition in the configuration register.

2. The method of claim 1, comprising managing resource allocation associated with the computing platform to the plurality of VMs through a resource manager stack executing on the hypervisor.

3. The method of claim 1, further comprising determining the subset of the engines of the GPU to be exposed to the application through a user of the computing platform to enable a subsequent definition of the data path.

4. The method of claim 1, comprising one of:
dynamically creating, through the hypervisor, the data path definition during creation of the plurality of VMs on the computing platform; and
pre-configuring the configuration register with the data path definition prior to the consolidation of the plurality of VMs on the computing platform.

5. The method of claim 1, comprising providing, through the driver component executing on the hypervisor, a configuration available to the instance of the driver component executing in the VM to be read by the instance of the driver component from the emulated version of the configuration register.

6. The method of claim 1, wherein when the GPU is part of a plurality of GPUs, the method further comprises configuring, through the hypervisor, another GPU of the computing platform with the subset of the engines of the GPU.

7. The method of claim 6, further comprising enabling migration of the VM from the GPU to the another GPU based on the common subset of the engines thereof.

8. A non-transitory medium, readable through a computing platform and including instructions embodied therein that are executable through the computing platform, comprising:
instructions to execute a driver component on a hypervisor of the computing platform comprising a GPU, the hypervisor being configured to consolidate a plurality of VMs on the computing platform comprising the GPU and to virtualize resources thereof, and the GPU executing a plurality of engines thereon;
instructions to execute an instance of the driver component in each of the plurality of VMs;
instructions to define, through the hypervisor, a data path between a VM and a subset of the engines of the GPU in a configuration register associated with the VM in accordance with a requirement of an application executing on the VM;
instructions to read, through the instance of the driver component in the VM, an emulated version of the configuration register during loading thereof; and
instructions to limit, through the hypervisor, at least one processing functionality provided to the VM based on solely exposing the subset of the engines of the GPU to the application executing thereon in accordance with the data path definition in the configuration register.

9. The non-transitory medium of claim 8, comprising instructions to manage resource allocation associated with the computing platform to the plurality of VMs through a resource manager stack executing on the hypervisor.

10. The non-transitory medium of claim 8, further comprising instructions to enable determination of the subset of the engines of the GPU to be exposed to the application through a user of the computing platform to enable a subsequent definition of the data path.

11. The non-transitory medium of claim 8, comprising one of:
instructions to dynamically create, through the hypervisor, the data path definition during creation of the plurality of VMs on the computing platform; and
instructions to pre-configure the configuration register with the data path definition prior to the consolidation of the plurality of VMs on the computing platform.

12. The non-transitory medium of claim 8, comprising instructions to provide, through the driver component executing on the hypervisor, a configuration available to the instance of the driver component executing in the VM to be read by the instance of the driver component from the emulated version of the configuration register.

13. The non-transitory medium of claim 8, wherein when the GPU is part of a plurality of GPUs, the non-transitory medium further comprises instructions to configure, through the hypervisor, another GPU of the computing platform with the subset of the engines of the GPU.

14. The non-transitory medium of claim 13, further comprising instructions to enable migration of the VM from the GPU to the another GPU based on the common subset of the engines thereof.

15. A computing platform comprising:
a memory;
a GPU communicatively coupled to the memory, the GPU being configured to execute a plurality of engines thereon; and
a hypervisor configured to consolidate a plurality of VMs on the computing platform and to virtualize resources thereof, the hypervisor including a driver component executing thereon, each of the plurality of VMs executing an instance of the driver component thereon, and the hypervisor further being configured to:
define a data path between a VM and a subset of the engines of the GPU in a configuration register associated with the VM in accordance with a requirement of an application executing on the VM, and
limit at least one processing functionality provided to the VM based on solely exposing the subset of the engines of the GPU to the application executing thereon in accordance with the data path definition in the configuration register,
wherein the instance of the driver component in the VM is configured to read an emulated version of the configuration register during loading thereof.

16. The computing platform of claim 15, wherein the hypervisor is further configured to execute a resource manager stack to manage resource allocation associated with the computing platform to the plurality of VMs.

17. The computing platform of claim 15, wherein one of:
the hypervisor is configured to enable dynamic creation of the data path definition during creation of the plurality of VMs on the computing platform, and
the configuration register is pre-configured with the data path definition prior to the consolidation of the plurality of VMs on the computing platform.

18. The computing platform of claim 15, wherein the driver component executing on the hypervisor provides a configuration available to the instance of the driver component executing in the VM to be read by the instance of the driver component from the emulated version of the configuration register.

19. The computing platform of claim 15, wherein at least one of:
the GPU is part of a plurality of GPUs, and
the hypervisor configures another GPU of the plurality of GPUs with the subset of the engines of the GPU.

20. The computing platform of claim 19, wherein the VM is migrated from the GPU to the another GPU based on the common subset of the engines thereof.
